(19) United States
(12) Patent Application Publication
(10) Pub. No.: US 2008/0319806 A1
(43) Pub. Date: Dec. 25, 2008

(54) Mealtime commerce and publishing in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/821,144

(22) Filed: Jun. 22, 2007

(51) Int. Cl. G06Q 30/00; G06Q 10/00

(52) U.S. Cl. 705/5; 705/1; 705/15

(57) ABSTRACT

A method, apparatus and system of mealtime commerce and publishing in a geo-spatial environment are disclosed. In one embodiment, a method includes generating a community network of user profiles, each user profile of the user profiles associated with a specific geographic location, generating meal events, each meal event of the meal events associated with a user profile of the user profiles, associating a first user with a first user profile, generating a first display view to include a three dimensional map view embodied by the community network and representation of a meal event associated with a second user profile of the user profiles represented at a location in the three dimensional map view associated with the specific geographic location of the second user profile of the user profiles, and simultaneously representing other user profiles adjacent to the second user profile in the three dimensional map view.

### FIELD OF TECHNOLOGY

This disclosure relates generally to the technical fields of communication hardware and/or software, and in one embodiment, to a method, system and apparatus of mealtime commerce and publishing in a geo-spatial environment.

### BACKGROUND

People love cooking. Popular food networks and cooking shows fuel the love of cooking. People may be eager to try new recipes and to share their cooking with neighbors and friends by hosting dinner parties, cookouts, etc. Gathering the neighbors and friends together for meals may be a slow, cumbersome process. A host may have to prepare invitations and wait for invitees to respond. The invitees may not be available on a particular date, or may be unable to accept the invitation on short notice.

For those invitees who do attend, some may find the menu displeasing or may have a taste for another cuisine. Further, the host may want feedback on various aspects of the meal. The invitees, however, may be reluctant to provide objective feedback for fear of offending the host, and may resort to overly optimistic comments. Alternatively, the host may open a restaurant to showcase his/her culinary talents. Such an endeavor, however, may prove effort-intensive, expensive, and/or financially unsustainable.

### SUMMARY OF THE DISCLOSURE

A method, apparatus and system of mealtime commerce and publishing in a geo-spatial environment are disclosed. In one aspect, a method includes generating a community network of user profiles, each user profile associated with a specific geographic location, generating meal events, each meal event associated with a user profile, associating a first user with a first user profile, generating a first display view to include a three dimensional map view embodied by the community network and a representation of a meal event associated with a second user profile represented at a location in the three dimensional map view associated with the specific geographic location of the second user profile, and simultaneously representing other user profiles adjacent to the second user profile in the three dimensional map view.

The method may also include associating the meal event (e.g., the meal event may be exempt from health regulations) with an ad hoc location. The ad hoc location may be selected from a group including a residence, a park, and a local gathering place. The method may include associating the meal event with a restaurant. The method may further include providing a type of meal event. Moreover, the type of meal event may be selected from a group including a cuisine, a menu, specific food items, a holiday meal and a special event meal.

The cuisine may be selected from a group including Indian, Italian, Iranian, Chinese, That, Japanese, Mediterranean, Mexican, Greek, Brazilian, Nepali, Cajun and Creole, Caribbean, Lebanese, Middle Eastern, Vietnamese, French, Spanish, American, Portuguese, Southwestern, Southern and Soul, Chilean, Moroccan, Cuban, Turkish, Swedish, Californian, German, Peruvian, Afghan, Ethiopian, Korean, Irish, and/or English, etc. The holiday meal may be selected from a group (e.g., of holidays) including Christmas, Kwanzaa, Hanukkah, New Year's, Fourth of July, Chinese New Year, Cinco de Mayo, Easter, Father's Day, Mother's Day, Ramadan, Halloween, Labor Day, Mardi Gras, Memorial Day, Oktoberfest, Passover, St. Patrick's Day, Thanksgiving, and/or Valentine's Day, etc.

The special event meal may be selected from a group including a birthday meal, a celebrated event meal, a religious event meal, a graduation meal, and a welcome to the neighborhood meal. The method may further include providing reservation and/or payment information associated with the meal event. The method may also include displaying a price of the meal event, displaying a total number of reservations provided at the meal event, displaying a total number of open reservations, reserving at least one open reservation, and generating an online payment transaction for payment of the meal event.

In addition, the method may include providing search criteria, selecting at least one search criterion, generating a second display view to include a three dimensional map view embodied by the community network and a representation of at least one meal event associated with the search criterion, and a user profile associated with the meal event, represented at a location in the three dimensional map view associated with the specific geographic location of the user profile associated with the meal event, and simultaneously representing other user profiles adjacent to the user profile associated with the meal event in the three dimensional map view. The search criterion may be selected from a group including a geographic area, a restaurant, a name, a street address of a residence, a cuisine, a menu, a food item, a meal event having open reservations, a date, a time, and/or a recipe, etc.

The method may further include providing recipes, selecting a recipe from the recipes, and displaying the recipe in a third display view. The method may also include providing a rating (e.g., displayed in conjunction with a wiki profile associated with the second user profile associated with the meal event and/or content associated with the wiki profile) of the meal event. Moreover, the method may include selecting at least one user profile, and automatically generating an invitation to the meal event to the user profile.

In another aspect, a system includes a geo-spatial environment, a community network module of the geo-spatial environment, to include user profiles, each user profile to include a specific geographic location, and meal events, each meal event associated with a user profile, a map module of the geo-spatial environment to include map data which serve as a basis to render a three dimensional map view in the geo-spatial environment which identifies residences, businesses, civic structures, dwellings, and/or meal events having specific geographic locations, and a display module of the geo-spatial environment to generate a first display view to include the three dimensional map view embodied by the community network and a representation of a particular meal event associated with a particular user profile represented at a location in the three dimensional map view associated with the specific geographic location of the particular user profile.

The system may also include a reservation module of the geo-spatial environment to generate a reservation associated with the particular meal event. The system may include a display reservations module of the geo-spatial environment to display a total number of reservations associated with the particular meal event, and a total number of open reservations associated with the particular meal event. The system may further include a commerce module of the geo-spatial environment to generate information and/or online transactions associated with the particular meal event.

Moreover, the system may include a payment module of the geo-spatial environment to provide payment information and/or to generate an online payment transaction associated with the particular meal event. In addition, the system may include a search module of the geo-spatial environment to provide search criteria associated with the meal events, to permit selection of at least one search criterion, and to generate meal events matching the search criterion of the meal events. The search criterion may be selected from a group including a geographic area, a venue, a type of meal event, a restaurant name, a person's name, a street address of a residence, a menu, a food item, a meal event with open reservations, a date, a time, and/or a recipe, etc.

The geographic area may be selected from a group including a neighborhood associated with a street address, a city, a county, a state, and/or a country, etc. The venue may be selected from a group including an ad hoc location (e.g., the ad hoc location may be a location where the particular meal event is exempt from health regulations) and/or a restaurant. The ad hoc location may be selected from a group including a residence, a park, and/or a local gathering place, etc.

The type of meal event may be selected from a group including a cuisine, a menu, specific food items, a holiday meal, and/or a special event meal. The cuisine may be selected from a group including Indian, Italian, Iranian, Chinese, That, Japanese, Mediterranean, Mexican, Greek, Brazilian, Nepali, Cajun and Creole, Caribbean, Lebanese, Middle Eastern, Vietnamese, French, Spanish, American, Portuguese, Southwestern, Southern and Soul, Chilean, Moroccan, Cuban, Turkish, Swedish, Californian, German, Peruvian, Afghan, Ethiopian, Korean, Irish, and/or English, etc. The holiday meal may be selected from a group including Christmas, Kwanzaa, Hanukkah, New Year's, Fourth of July, Ramadan, Chinese New Year, Cinco de Mayo, Easter, Father's Day, Mother's Day, Halloween, Labor Day, Mardi Gras, Memorial Day, Oktoberfest, Passover, St. Patrick's Day, Thanksgiving, and/or Valentine's Day, etc. The special meal event meal may be selected from a group including a birthday meal, a celebrated event meal, a religious event meal, a graduation meal, and/or a welcome to the neighborhood meal, etc.

The system may further include a rating module of the geo-spatial environment to enable ratings of the meal events. The system may also include a wiki profile module of the geo-spatial environment to generate in the first display view a wiki profile associated with a user profile. In addition, the system may include an append module of the geo-spatial environment to generate, with at least one wiki profile, content associated with the wiki profile.

In yet another aspect, a geo-spatial environment includes a first instruction set to enable a community network, to include a map database associated with map data, a user database associated with user profiles, each user profile associated with a specific geographic location identifiable in the map data, and a meal event database associated with meal events, each meal event associated with a user profile, and a second instruction set integrated with the first instruction set to display a three dimensional map view, embodied by the community network, to include representations of at least a portion of the meal events and/or representations of the user profiles associated with the portion of the meal events displayed at a location in the three dimensional map view corresponding to the specific geographic location associated with each user profile associated with the portion of the meal events.

The geo-spatial environment may also include a third instruction set to generate a reservation and/or an online payment transaction associated with the meal event. The geo-spatial environment may further include a fourth instruction set to generate a search, associated with the meal events, based on at least one search criterion. In addition, the geo-spatial environment may also include a fifth instruction set to enable ratings of the meal events.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of events associated with mealtime commerce, according to one embodiment.

FIG. 5 is a block diagram representation of search criteria, according to one embodiment.

FIG. 6 is a user interface view showing a user profile associated with a meal event, according to one embodiment.

FIG. 7 is a user interface view of booking of a reservation associated with the meal event, according to one embodiment.

FIG. 8 is a user interface view of the online payment transaction, according to one embodiment.

FIG. 9 is a user interface view of searching a meal event based on the search criteria, according to one embodiment.

FIG. 10 is a user interface view showing matching meal events associated with a specific geographic location, according to one embodiment.

FIG. 11 is a user interface view showing ratings associated with a meal event, according to one embodiment.

FIG. 12 is a user interface view showing ratings provided by a user associated with the meal event, according to one embodiment.

FIG. 13 is a table view showing information associated with the meal events, according to one embodiment.

FIG. 14 is a diagrammatic system view of a data processing system in which any of the embodiments disclosed herein may be performed, according to one embodiment.

FIG. 15A is a process flow of generating meal events associated with the user profiles, according to one embodiment.

FIG. 15B is a continuation of the process flow of FIG. 15A, showing additional processes, according to one embodiment.

FIG. 15C is a continuation of the process flow of FIG. 15B, showing additional processes, according to one embodiment.

FIG. 15D is a continuation of the process flow of FIG. 15C, showing additional processes, according to one embodiment.

Other features of the present embodiments will be apparent from the accompanying drawings and from the detailed description that follows.

### DETAILED DESCRIPTION

A method, system and apparatus of mealtime commerce and publishing in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

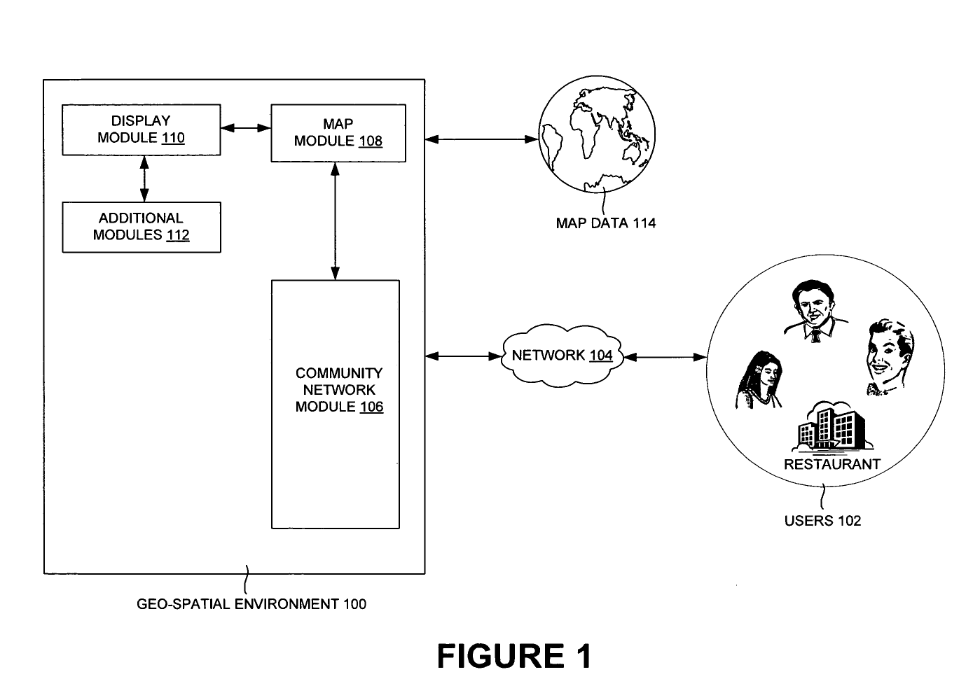

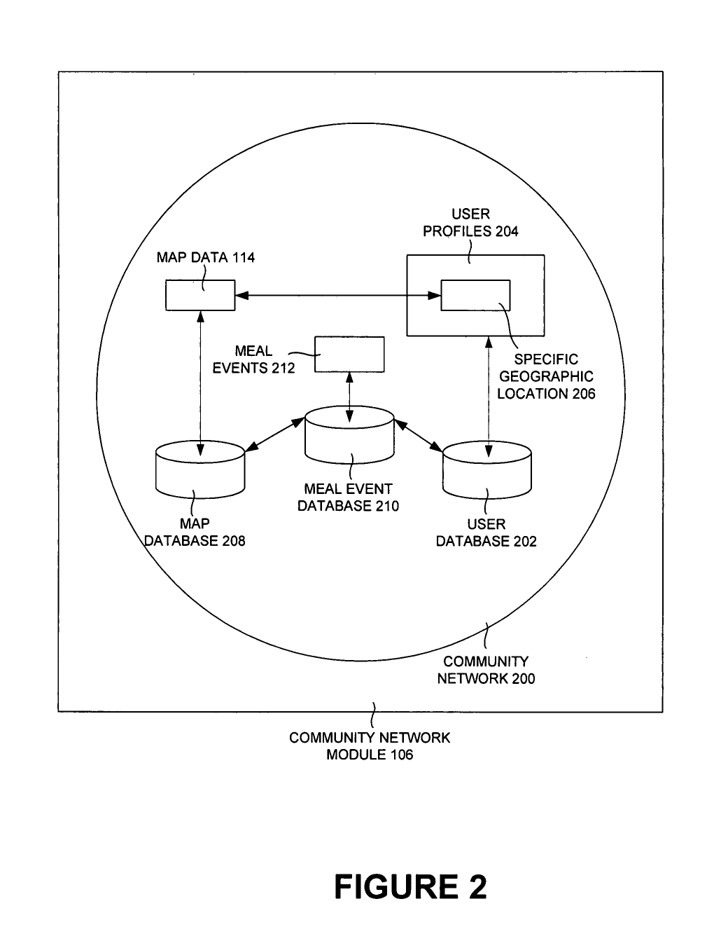

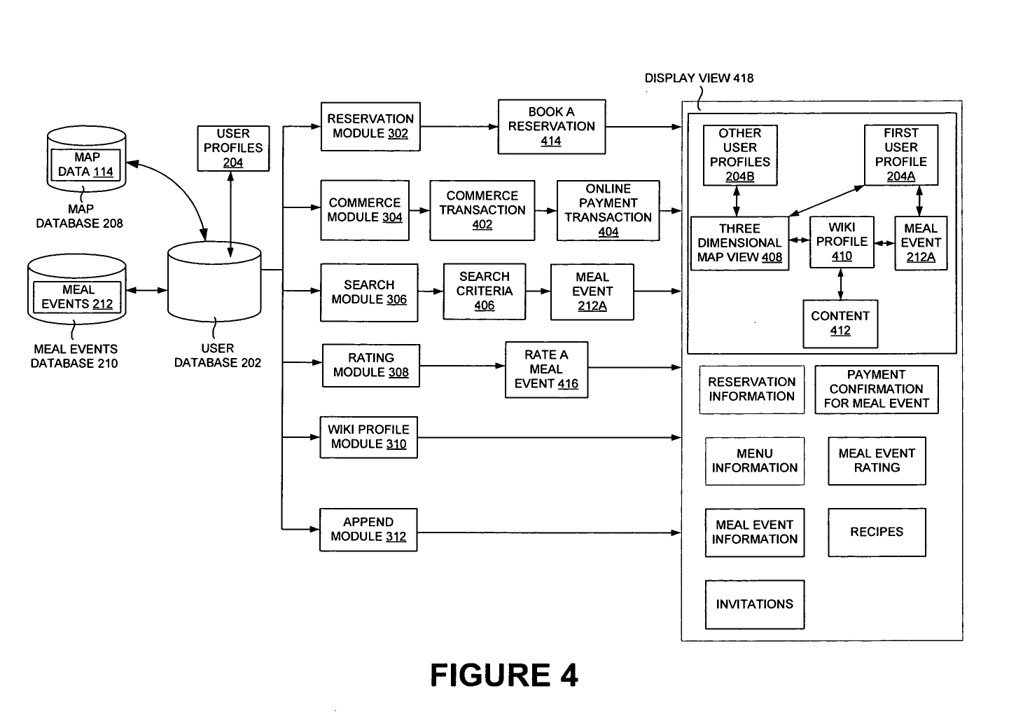

In one embodiment, a method includes generating a community network (e.g., the community network 200 of FIG. 2) of user profiles (e.g., the user profiles 204 of FIG. 2), each user profile 204 associated with a specific geographic location (e.g., the specific geographic location 206 of FIG. 2), generating meal events (e.g., the meal events 212 of FIG. 2), each meal event 212 associated with a user profile 204, associating a first user (e.g., of the users 102 of FIG. 1) with a first user profile (e.g., the first user profile 204A of FIG. 4), generating a first display view (e.g., the display view 418 of FIG. 4) to include a three dimensional map view (e.g., the three dimensional map view 408 of FIG. 4) embodied by the community network 200 and a representation of a meal event 606 associated with a second user profile 204 represented at a location in the three dimensional map view 408 associated with the specific geographic location 206 of the second user profile 204, and simultaneously representing other user profiles (e.g., the other user profiles 204B of FIG. 4) adjacent to the second user profile 204 in the three dimensional map view 408.

In another embodiment, a system includes a geo-spatial environment (e.g., the geo-spatial environment 100 of FIG. 1), a community network module (e.g., the community network module 106 of FIG. 1) of the geo-spatial environment 100, to include user profiles 204, each user profile 204 to include a specific geographic location (e.g., the specific geographic location 206 of FIG. 2), and meal events 212, each meal event 212 associated with a user profile 204, a map module (e.g., the map module 108 of FIG. 1) of the geo-spatial environment 100 to include map data (e.g., the map data 114 of FIGS. 1-2) which serve as a basis to render a three dimensional map view (e.g., the three dimensional map view 408 of FIG. 4) in the geo-spatial environment 100 which identifies residences, businesses, civic structures, dwellings, and/or meal events having specific geographic locations 206, and a display module (e.g., the display module 110 of FIG. 1) of the geo-spatial environment 100 to generate a first display view (e.g., the display view 418 of FIG. 4) to include the three dimensional map view 408 embodied by the community network 200 and a representation of a particular meal event (e.g., the meal event 212A of FIG. 4) associated with a particular user profile 204 represented at a location in the three dimensional map view 408 associated with the specific geographic location 206 of the particular user profile 204.

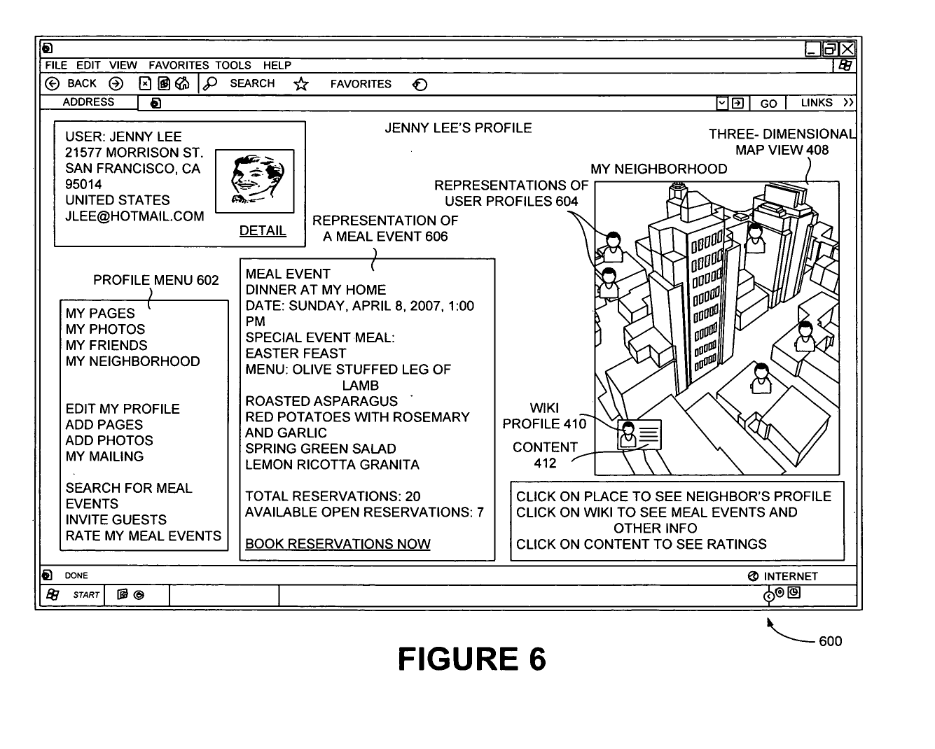

In yet another embodiment, a geo-spatial environment (e.g., the geo-spatial environment 100 of FIG. 1) includes a first instruction set to enable a community network (e.g., the community network 200 of FIG. 2), to include a map database (e.g., the map database 208 of FIG. 2) associated with map data (e.g., the map data 114 of FIGS. 1-2), a user database (e.g., the user database 202 of FIG. 2) associated with user profiles (e.g., the user profiles 204 of FIG. 2), each user profile 204 associated with a specific geographic location (e.g., the specific geographic location 206 of FIG. 2) identifiable in the map data 114, and a meal event database (e.g., the meal event database 210 of FIG. 2) associated with meal events (e.g., the meal events 212 of FIG. 2), each meal event 212 associated with a user profile 204, and a second instruction set integrated with the first instruction set to display a three dimensional map view (e.g., the three dimensional map view 408 of FIG. 4), embodied by the community network 200, to include representations of at least a portion of the meal events 212 (e.g., the representation of a meal event 606 of FIG. 6) and representations of the user profiles 204 associated with the portion of the meal events 212 displayed at a location in the three dimensional map view 408 corresponding to the specific geographic location 206 associated with each user profile 204 associated with the portion of the meal events 212.

FIG. 1 is a system view of a geo-spatial environment 100 communicating with users 102 through a network 104, according to one embodiment. Particularly, FIG. 1 illustrates the geo-spatial environment 100, the users 102, the network 104, a community network module 106, a map module 108, a display module 110, additional modules 112, and a map data 114, according to one embodiment.

The geo-spatial environment 100 may enable a mealtime commerce based on specific geographic locations. The users 102 may be entities (e.g., individuals and/or restaurant, etc.) associated with user profiles (e.g., the user profiles 204 of FIG. 2) of a community network (e.g., the community network 200 of FIG. 2) having the specific geographic locations 206 in the geo-spatial environment 100. The network 104 may facilitate communication between the users 102 to enable the mealtime commerce in the geo-spatial environment 100. The community network module 106 may generate the community network 200 with the user profiles 204 associated with the specific geographic locations 206.

The map module 108 may generate a three dimensional map view (e.g., the three dimensional map view 408 of FIG. 4) which includes residences, businesses, civic structures, dwellings, and/or meal events having the specific geographic locations 206 in the geo-spatial environment 100. The map module 108 may also display the user profiles 204 associated with meal events 212 along with other profiles in the three dimensional map view 408. The display module 110 may display the meal events 212 associated with the user profiles 204 having the specific geographic locations in the three dimensional map view 408. The additional modules 112 may generate additional processes to enable the mealtime commerce among the users 102 in the geo-spatial environment 100. The map data 114 may be address data and/or location data associated with the user profiles 204 that serve as a basis to render the three dimensional map view 408.

In the example embodiment illustrated in FIG. 1, the geo-spatial environment 100 communicates with the users 102 through the network 104. The geo-spatial environment 100 also communicates (e.g., processes) the map data 114. The geo-spatial environment 100 includes the community network module 106, the map module 108, the display module 110 and the additional modules 112, communicating with each other.

The geo-spatial environment 100 may include the community network module 106, to include the user profiles 204, each user profile 204 to include a specific geographic location (e.g., the specific geographic location 206 of FIG. 2), and the meal events 212, each meal event 212 associated with a user profile 204. The map module 108 of the geo-spatial environment 100 may include the map data 114 which serves as the basis to render the three dimensional map view 408 in the geo-spatial environment 100 which identifies residences, businesses, civic structures, dwellings, and/or meal events having the specific geographic locations 206.

The display module 110 of the geo-spatial environment 100 may generate a first display view (e.g., the display view 418 of FIG. 4) to include the three dimensional map view 408 embodied by the community network 200 and a representation of a particular meal event (e.g., the representation of a meal event 606 of FIG. 6) associated with a particular user profile 204 represented at a location in the three dimensional map view 408 associated with the specific geographic location 206 of the particular user profile 204.

FIG. 2 is an exploded view of the community network module 106 of FIG. 1, according to one embodiment. Particularly, FIG. 2 illustrates the map data 114, a community network 200, a user database 202, user profiles 204, a specific geographic location 206, a map database 208, a meal event database 210, and meal events 212, according to one embodiment.

The community network 200 may be a network of the user profiles 204 which enables the mealtime commerce among the users 102 in the geo-spatial environment 100. The user database 202 may contain details (e.g., name, address data, and/or location data, etc.) of the users 102 involved in the mealtime commerce. The user profiles 204 may be profiles having specific geographic locations 206 generated from the user database 202. The specific geographic location 206 may be a particular area where the communication between the users 102 occurs to enable the mealtime commerce.

The map database 208 may generate the map data 114 (e.g., the address data and/or the location data, etc.) that serves as the basis to render the three dimensional map view 408. The meal event database 210 may generate the meal events 212 associated with the user profiles 204 having the specific geographic location 206. The meal events 212 may be events associated with the user profiles 204 in the geo-spatial environment 100.

In the example embodiment illustrated in FIG. 2, the community network module 106 consists of the community network 200 that includes the user database 202, the map database 208 and the meal event database 210 from which the user profiles 204, the map data 114 and the meal events 212, associated with the specific geographic location 206 are generated to enable the mealtime commerce in the geo-spatial environment 100.

The community network 200 of the user profiles 204 may be generated, each user profile 204 associated with a specific geographic location (e.g., the specific geographic location 206 of FIG. 2). The meal events 212 may be generated, each meal event 212 associated with a user profile. A first user 102 may be associated with a first user profile (e.g., the first user profile 204A of FIG. 4). The meal event 212 (e.g., the meal event may be exempt from health regulations) may be associated with an ad hoc location (e.g., may be selected from a group including a residence, a restaurant, a park, and/or a local gathering place, etc.).

A type of meal event may also be provided (e.g., the type of meal event may be selected from a group including a cuisine, a menu, specific food items, a holiday meal, and/or a special event meal, etc.). For example, the cuisine may be selected from a group including Indian, Italian, Iranian, Chinese, That, Japanese, Mediterranean, Mexican, Greek, Brazilian, Nepali, Cajun and Creole, Caribbean, Lebanese, Middle Eastern, Vietnamese, French, Spanish, American, Portuguese, Southwestern, Southern and Soul, Chilean, Moroccan, Cuban, Turkish, Swedish, Californian, German, Peruvian, Afghan, Ethiopian, Korean, Irish, and/or English, etc.

The holiday meal may be selected from a group including Christmas, Kwanzaa, Hanukkah, New Year's, Fourth of July, Chinese New Year, Cinco de Mayo, Easter, Father's Day, Mother's Day, Halloween, Ramadan, Labor Day, Mardi Gras, Memorial Day, Oktoberfest, Passover, St. Patrick's Day, Thanksgiving, and/or Valentine's Day, etc. The special event meal may be selected from a group including a birthday meal, a celebrated event meal, a religious event meal, a graduation meal, and/or a welcome to the neighborhood meal.

The geo-spatial environment 100 may include a first instruction set to enable the community network 200, to include the map database 208 associated with the map data 114, the user database 202 associated with the user profiles 204, each user profile 204 associated with the specific geographic location 206 identifiable in the map data 114, and the meal event database 210 associated with the meal events 212, each meal event 212 associated with a user profile 204.

A second instruction set of the geo-spatial environment 100 integrated with the first instruction set may display the three dimensional map view 408, embodied by the community network 200, to include representations of a portion of the meal events 212 (e.g., the representation of a meal event 606 of FIG. 6) and representations of the user profiles 204 associated with the portion of the meal events 212 displayed at a location in the three dimensional map view 408 corresponding to the specific geographic location 206 associated with each user profile 204 associated with the portion of the meal events 212.

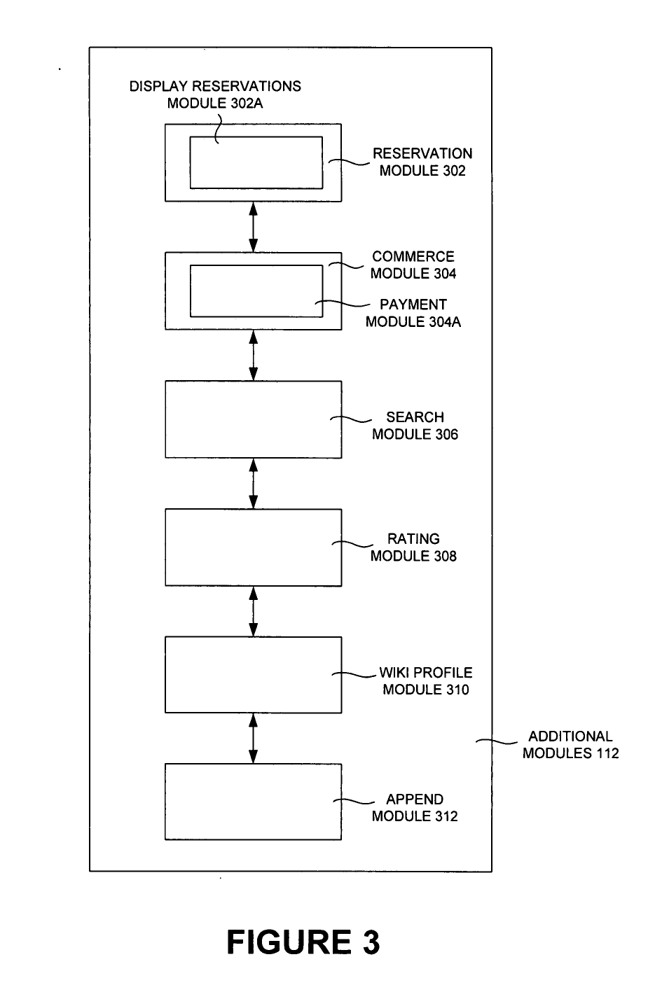

FIG. 3 is an exploded view of the additional modules 112 of FIG. 1, according to one embodiment. Particularly, FIG. 3 illustrates a reservation module 302, a display reservations module 302A, a commerce module 304, a payment module 304A, a search module 306, a rating module 308, a wiki profile module 310, and an append module 312, according to one embodiment.

The reservation module 302 may enable the users 102 to reserve various meal events associated with the user profiles 204 in the geo-spatial environment 100. The display reservations module 302A may display a reservation chart associated with the meal events 212 which may include, for example, a number of seats reserved for the meal events 212 and/or a number of available reservations (e.g., referred to as open reservations). The commerce module 304 may generate transactions (e.g., online transactions) associated with the meal events 212 in the geo-spatial environment 100. The payment module 304A may generate payment transactions associated with the meal events 212 in the geo-spatial environment 100.

The search module 306 may enable the users 102 of the geo-spatial environment 100 to search for a particular meal event associated with a user profile 204 based on search criteria (e.g., the search criteria 406 of FIG. 4). The rating module 308 may enable ratings (e.g., on taste, ambience, and/or presentation, etc.) of the meal events 212 by the users 102 of the geo-spatial environment 100. The wiki profile module 310 may generate wiki profiles (e.g., wiki profiles 410 of FIG. 4) associated with the users 102 of the geo-spatial environment 100. The append module 312 may enable the users 102 to add content to the wiki profiles 410 during the generation of the wiki profiles 410.

In the example embodiment as illustrated in FIG. 3, the additional modules 112 consist of the reservation module 302, the display reservations module 302A, the commerce module 304, the payment module 304A, the search module 306, the rating module 308, the wiki profile module 310, and the append module 312, communicating with each other.

The reservation module 302 of the geo-spatial environment 100 may generate the reservation associated with the particular meal event 212. The display reservations module 302A of the geo-spatial environment 100 may display a total number of reservations associated with the particular meal event 212 and/or a total number of the open reservations associated with the particular meal event 212. The commerce module 304 of the geo-spatial environment 100 may generate information and/or online transactions associated with the particular meal event 212.

The payment module 304A of the geo-spatial environment 100 may provide payment information and/or may generate an online payment transaction associated with the particular meal event 212. The search module 306 of the geo-spatial environment 100 may provide the search criteria 502 associated with the meal events 212 to permit selection of a search criterion, and/or may generate meal events 212 matching the search criterion of the meal events 212.

The search criterion may be selected from a group including a geographic area, a venue, a type of meal event, a restaurant name, a person's name, a street address of a residence, a menu, a food item, a meal event with open reservations, a date, a time, and/or a recipe, etc. The geographic area may be selected from a group including a neighborhood associated with a street address, a city, a county, a state, and/or a country, etc. The venue may be selected from a group including an ad hoc location and/or a restaurant, etc. The ad hoc location may be selected from the group including a residence, a park, and/or a local gathering place, etc. The ad hoc location may include a location (e.g., a house) where the particular meal event 212 is exempt from health regulations.

The type of meal event 212 may be selected from the group including a cuisine, a menu, specific food items, a holiday meal, and/or a special event meal, etc.

The rating module 308 of the geo-spatial environment 100 may enable ratings of the meal events 212. The wiki profile module 310 of the geo-spatial environment 100 may generate in the first display view 418, a wiki profile (e.g., the wiki profile 410 of FIG. 4) associated with a user profile 204. The append module 312 of the geo-spatial environment 100 may generate with the wiki profile 410, content associated with the wiki profile 410.

A third instruction set of the geo-spatial environment 100 may generate the reservation (e.g., using the reservation module 302 of FIG. 3) and/or the online payment transaction (e.g., the online payment transaction 404 of FIG. 4) associated with the meal event 212. A fourth instruction set of the geo-spatial environment 100 may generate the search (e.g., using the search module 306 of FIG. 3), associated with the meal events 212, based on the search criterion. A fifth instruction set of the geo-spatial environment 100 may enable the ratings of the meal events 212 (e.g., using the rating module 308 of FIG. 3).

FIG. 4 is a block diagram illustrating generation of events associated with the mealtime commerce, according to one embodiment. Particularly, FIG. 4 illustrates the map data 114, the user database 202, the user profiles 204, a first user profile 204A, other user profiles 204B, the map database 208, the meal events database 210, the meal events 212, a meal event 212A, the reservation module 302, the commerce module 304, the search module 306, the rating module 308, the wiki profile module 310, the append module 312, a commerce transaction 402, an online payment transaction 404, search criteria 406, a three dimensional map view 408, a wiki profile 410, a content 412, a book a reservation 414, a rate a meal event 416, and a display view 418, according to one embodiment.

The commerce transaction 402 may be a transaction associated with the meal events 212 in the geo-spatial environment 100. The online payment transaction 404 may relate to online monetary transactions associated with the meal events 212. The search criteria 406 may serve as a tool based on which the search for the particular meal event 212 is performed.

The three dimensional map view 408 may enable the users 102 of the geo-spatial environment 100 to visualize their neighborhood to search for the desired meal events 212. The wiki profile 410 may be a profile associated with a user 102 that is represented in the three dimensional map view 408. The content 412 may be comments and/or the ratings associated with the meal events 212 that are added to the wiki profile 410 by the users 102 of the geo-spatial environment 100. The book a reservation 414 may enable the users 102 to reserve the seats for the meal events 212 associated with the user profiles 204. The rate a meal event 416 may enable the ratings of the meal events 212 based on taste, appearance, presentation, and/or ambience, etc. The display view 418 may display the meal events 212 in the neighborhood along with the user profiles 204 in the three dimensional map view 408.

In the example embodiment as illustrated in FIG. 4, the display view 418 includes the three dimensional map view 408 and a representation of a meal event 606. The users 102 of the geo-spatial environment 100 may search for the particular meal event 212 based on the search criteria 406. The display view 418 also shows the first user profile 204A, the other user profiles 204B and the wiki profile 410 generated from the user database 202. The users 102 may book the reservation for the desired meal events 212 and/or also rate the meal events 212 associated with the user profiles 204. The monetary transactions associated with the meal events 212 may be performed through the online payment transaction 404. The display view 418 also enables the users 102 to visualize menu information, ratings, invitations to the meal events, recipes and/or online cooking videos, etc.

The first display view (e.g., the display view 418 of FIG. 4) may include the three dimensional map view 408 embodied by the community network 200 and the representation of a meal event 606 associated with a second user profile 204 represented at the location in the three dimensional map view 408 associated with the specific geographic location 206 of the second user profile 204.

The other user profiles 204B may be simultaneously represented adjacent to the second user profile 204 in the three dimensional map view 408. The online payment transaction 404 may be generated for payment of the meal event 212A. The search criteria 406 may be provided and/or a search criterion may be selected (e.g., from a group including a geographic area, a restaurant, a name, a street address of a residence, a cuisine, a menu, a food item, a meal event having open reservations, a date, a time, and a recipe. A second display view (e.g., the display view 418 of FIG. 4) may be generated to include the three dimensional map view 408 embodied by the community network 200 and the representation of a meal event 606 associated with the search criterion, and the user profile (e.g., the first user profile 204A of FIG. 4) associated with the meal event 212A, represented at a location in the three dimensional map view 408 associated with the specific geographic location 206 of the user profile associated with the meal event 212A.

The other user profiles 204B may be simultaneously represented adjacent to the user profile 204 associated with the meal event 212A in the three dimensional map view 408. The recipe (e.g., may include the online cooking video) may also be displayed in a third display view.

The rating (e.g., displayed in conjunction with a wiki profile 410 associated with the second user profile 204 associated with the meal event 212A, and/or content associated with the wiki profile 410) of the meal event 212A may be provided. A user profile 204 may be selected and/or an invitation to the meal event 212A may be automatically generated to the user profile 204.

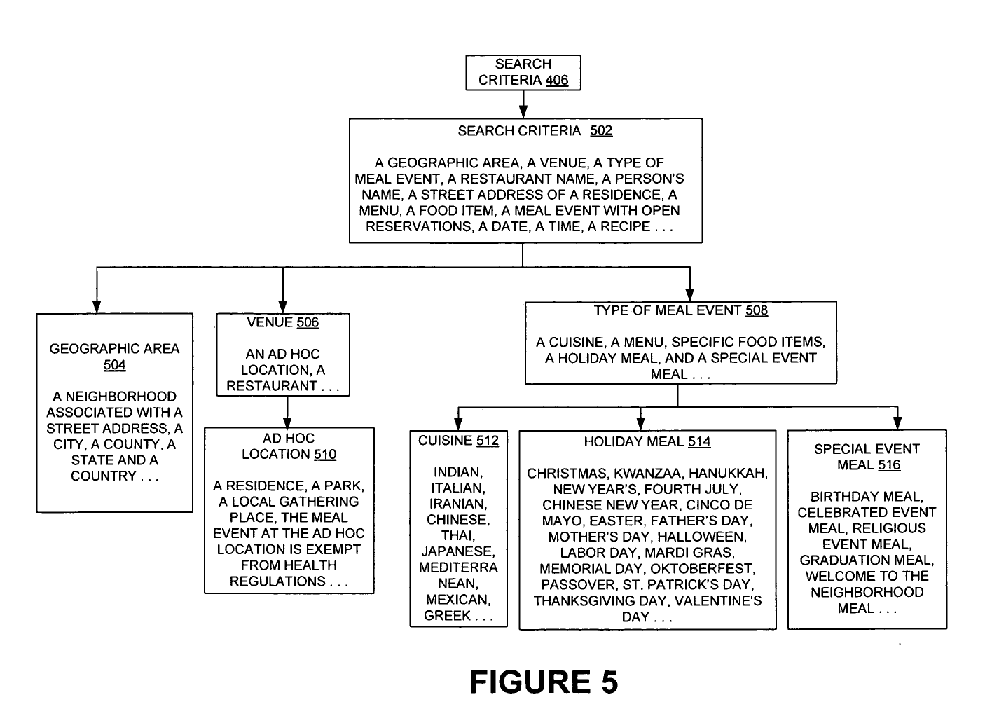

FIG. 5 is a block diagram representation of the search criteria 406, according to one embodiment. Particularly, FIG. 5 illustrates search criteria 502, a geographic area 504, a venue 506, a type of meal event 508, an ad hoc location 510, a cuisine 512, a holiday meal 514, and a special event meal 516, according to one embodiment.

The search criteria 406 may serve as a tool based on which the search for the desired meal event 212 is performed. The search criteria 406 may be selected from a group including a geographic area, a restaurant, a name, a street address of a residence, a cuisine, a menu, a food item, a meal event having open reservations, a date, a time, and/or a recipe, etc.

In the example embodiment illustrated in FIG. 5, the users 102 of the geo-spatial environment 100 may search for the desired meal event using the search criteria 406. The search criteria 406 may narrow down the search for the desired meal events 212 (e.g., performed by the users 102). The search criteria geographic area 504 includes a neighborhood associated with a street address, a city, a county, a state and/or a country, etc. The venue 506 includes an ad hoc location and/or a restaurant where the meal event 212 may take place.

The ad hoc location 510 includes a residence, a park, and/or a local gathering place where the meal event may be exempt from health regulations. The users 102 may also select the meal events 212 based on a category of the meal event (e.g., a cuisine, a menu, specific food items, a holiday meal and/or a special event meal, etc.). The cuisine 512 may include Indian, Italian, Iranian, Chinese, That, Japanese, Mediterranean, Mexican, and/or Greek, etc. The holiday meal 514 may be associated with Christmas, Kwanzaa, Hanukkah, New Year, Ramadan, Halloween, Thanksgiving, and/or Valentine's day, etc. The special event meal 516 may be based on certain special occasions like a birthday meal, a religious meal and/or a graduation meal.

FIG. 6 is a user interface view 600 showing a user profile associated with a meal event, according to one embodiment. Particularly, FIG. 6 illustrates the three dimensional map view 408, the wiki profile 410, the content 412, a profile menu 602, representations of user profiles 604, and a representation of a meal event 606, according to one embodiment.

The profile menu 602 may display profile details (e.g., photos, friends, neighborhood, meal events, etc.) of a user 102 associated with the meal event 212A. The representations of user profiles 604 may be the user profiles 204 and/or the wiki profiles displayed in the three dimensional map view 408. The representation of a meal event 606 may display details (e.g., time, venue, menu, etc.) of the meal event 212A associated with the user profile 204.

In the example embodiment illustrated in FIG. 6, the user interface view 600 displays the profile details of a host (e.g., Jenny Lee) of the meal event 212A. The three dimensional map view 408 may represent a map view of the specific geographic location 206 associated with the meal event 212A. The users 102 of the geo-spatial environment 100 may click on the wiki profile 410 and/or the content 412 to visualize the user profiles 204 and/or the meal events 212 in their neighborhood on the three dimensional map view 408.

The users 102 may see the details of the meal event 212A in the community network 200 through the representation of a meal event 606 and/or may view the ratings on the various meal events associated with the user profiles 204. The details of the meal event 212A include date, time, venue, menu and/or the open reservations available. The representation of a meal event 606 also provides an option for the users 102 of the geo-spatial environment 100 to book the reservation for the meal event 212A based on the open reservations available.

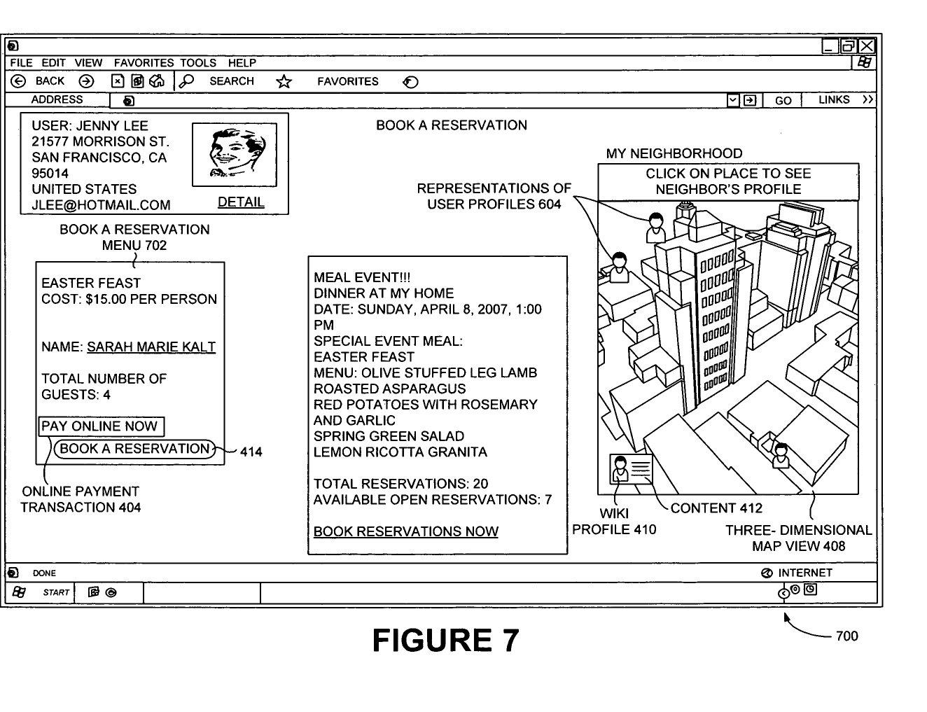

FIG. 7 is a user interface of booking of the reservation associated with the meal event 212, according to one embodiment. Particularly, FIG. 7 illustrates the online payment transaction 404, the three dimensional map views 408, the wiki profile 410, the content 412, the book a reservation 414, the representations of user profiles 604, and a book a reservation menu 702, according to one embodiment.

The book a reservation menu 702 may display the reservation details of the meal events 212 associated with the user profiles 204 in the geo-spatial environment 100.

In the example embodiment illustrated in FIG. 7, the user interface view 700 displays the book a reservation menu 702 that shows details of a particular meal event 212. The details include name of guests invited for the meal event, cost incurred per person and/or number of open reservations available. The users 102 of the geo-spatial environment 100 may book the reservations for the meal event 212 (e.g., using the reservation module 302 of FIG. 3) based on the number of open reservations available. The online payment transaction 404 may be also be processed (e.g., using the commerce module 304 of FIG. 3) while the reservations are being submitted by the users 102.

The reservation and/or the payment information associated with the meal event 212A may be provided. A price of the meal event may be displayed (e.g., using the book a reservation menu 702 of FIG. 7). The total number of reservations provided at the meal event 212A may be provided. The total number of the open reservations may be displayed and/or an open reservation may be reserved by a user 102.

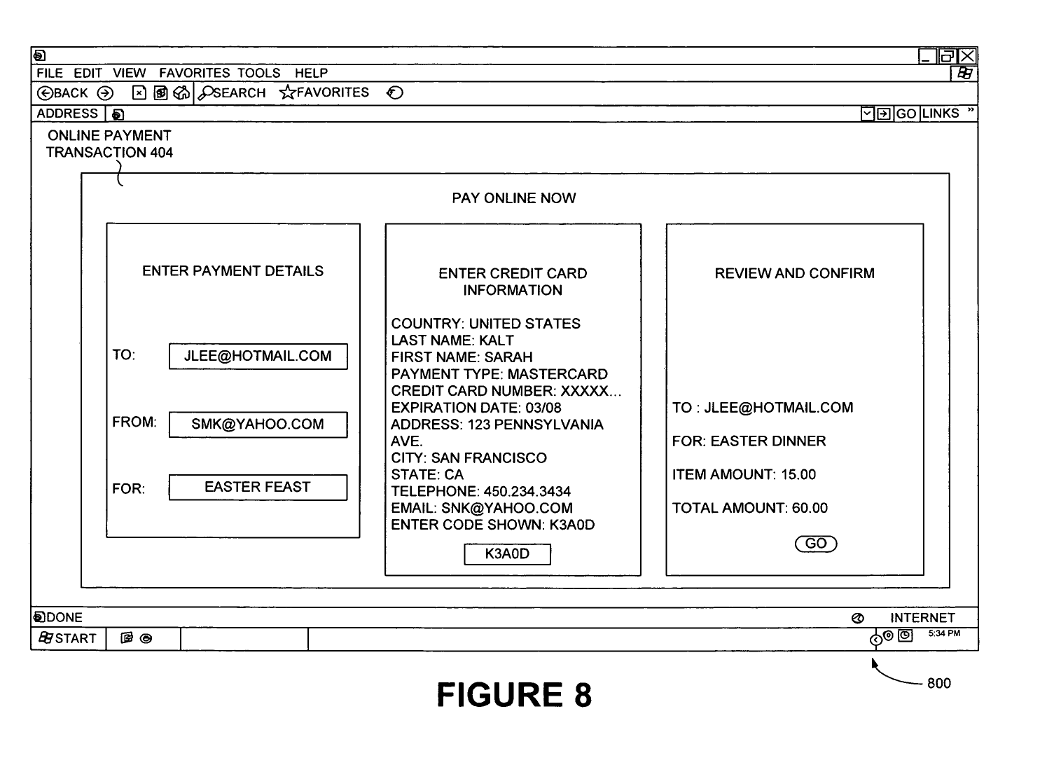

FIG. 8 is a user interface view 800 of the online payment transaction 404, according to one embodiment. Particularly, FIG. 8 illustrates the online payment transaction 404, according to one embodiment. The online payment transaction 404 may relate to the online monetary transactions associated with the meal events 212.

In the example embodiment as illustrated in FIG. 8, the online payment transaction 404 displays online payment related content associated with the meal event 212A. The payment details include the host name, guest name, and occasion of the meal event 212A for which the reservation and/or the payment is made. The pay online facility may enable the users 102 involved in the mealtime commerce to enter payment details, a credit card number, and/or may enable the users 102 to review and/or confirm the online payment transaction 404.

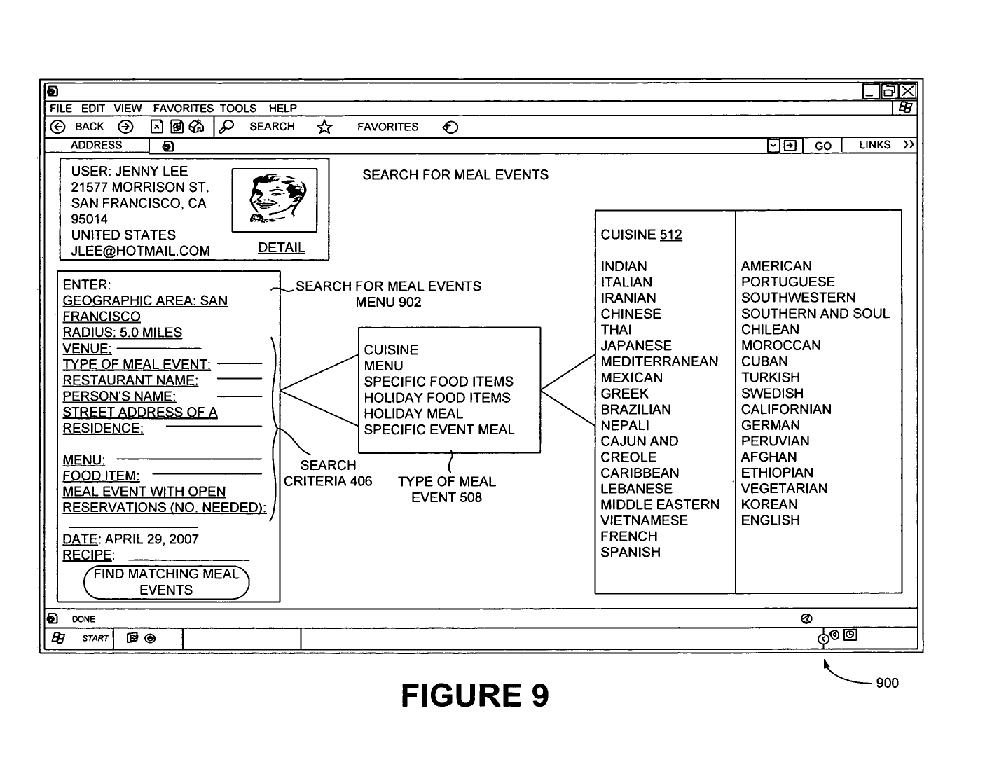

FIG. 9 is a user interface view 900 of searching of a meal event based on the search criteria 502, according to one embodiment. Particularly, FIG. 9 illustrates the search criteria 406, the type of meal event 508, the cuisine 512, and a search for meal events menu 902, according to one embodiment. The search for meal events menu 902 may display the search criteria 502 based on which the users 102 of the geo-spatial environment 100 search for the desired meal events.

In the example embodiment illustrated in FIG. 9, the user interface view 900 displays the search criteria 502 (e.g., venue, type of meal event, restaurant name, person's name and/or cuisine, etc.) from which the users 102 may select a particular search criterion to search for the desired meal event. The users 102 may find meal events matching their search criteria 406 and/or reserve seats for the meal events 212. Different cuisines like Indian, Italian, Iranian, Chinese, and/or That, etc. may be available from which the users 102 choose their desired meal.

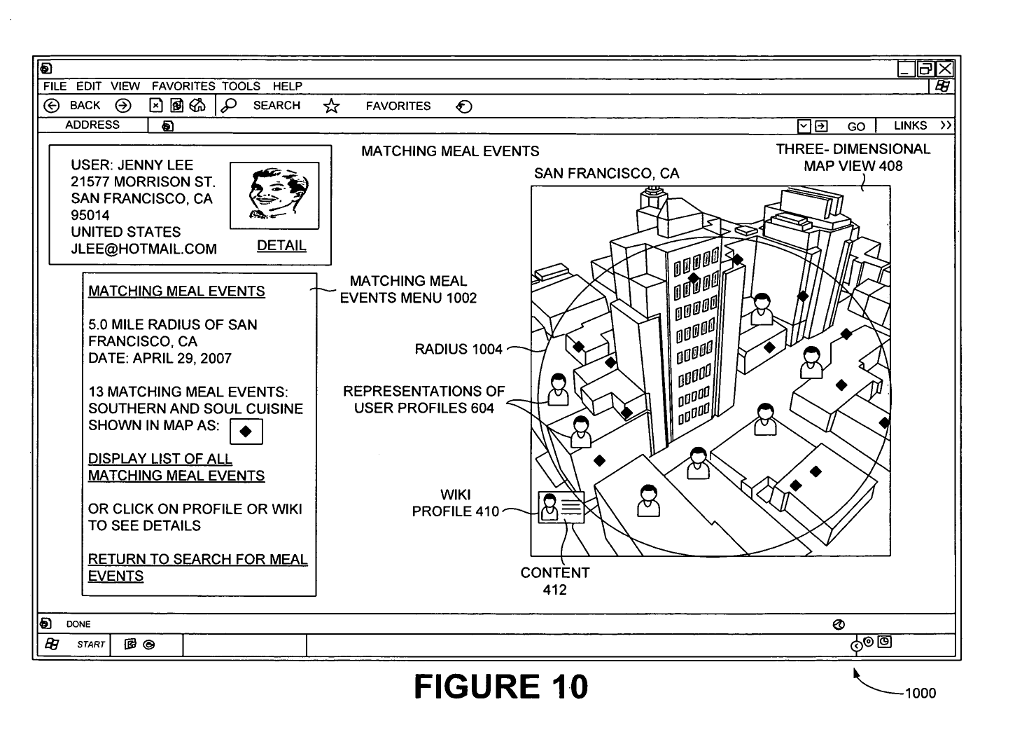

FIG. 10 is a user interface view 1000 showing matching meal events 212 associated with a specific geographic location 206, according to one embodiment. Particularly, FIG. 10 illustrates the three dimensional map view 408, the wiki profile 410, the content 412, the representations of user profiles 604, a matching meal events menu 1002, and a radius 1004, according to one embodiment.

The matching meal events menu 1002 may display a list of meal events 212 matching the search criteria 406 provided by the users 102 of the geo-spatial environment 100. The radius 1004 may be a geo-fenced area associated with a specified location 206 which encompasses the meal events 212 matching the search criteria 406 provided by the users 102.

In the example embodiment illustrated in FIG. 10, the user interface view 1000 displays the three dimensional map view 408 with the radius 1004 showing the geo-fenced area where the search for the desired meal event 212 is performed. A number of matching meal events 212 found in the geo-fenced area is specified in the matching meal events menu 1002, locations of which are represented in the three dimensional map view 408.

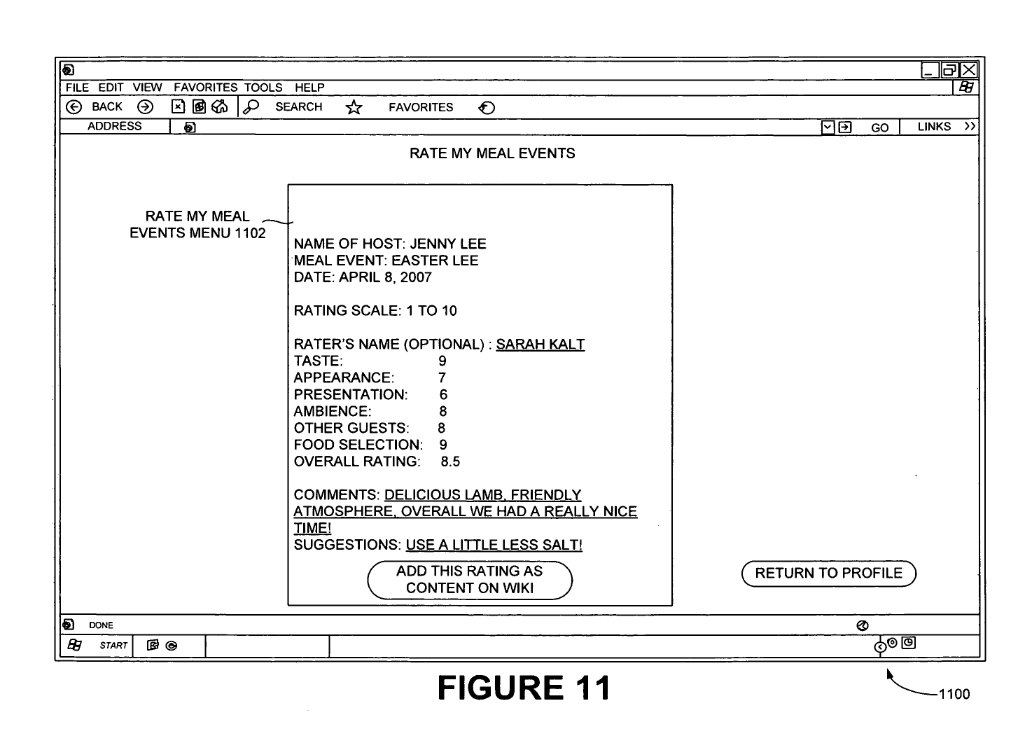

FIG. 11 is a user interface view 1100 showing ratings associated with a meal event 212, according to one embodiment. Particularly, FIG. 11 illustrates a rate my meal events menu 1102, according to one embodiment. The rate my meal events menu 1102 may display the ratings (e.g., taste, ambience, etc.) provided by the users 102 of the geo-spatial environment 100 to the meal event 212A.

In the example embodiment illustrated in FIG. 11, the user interface view 1100 displays the rate my meal events menu 1102 that includes the name of the host, meal event, date, rating scale (e.g., from 1 to 10), rater's name, remarks on taste, appearance, presentation, ambience, other guests, food selection, and/or overall ratings. The users 102 may write comments and/or suggestions about the meal event 212A that are added as content on the wiki profiles of the users 102 associated with the meal events 212.

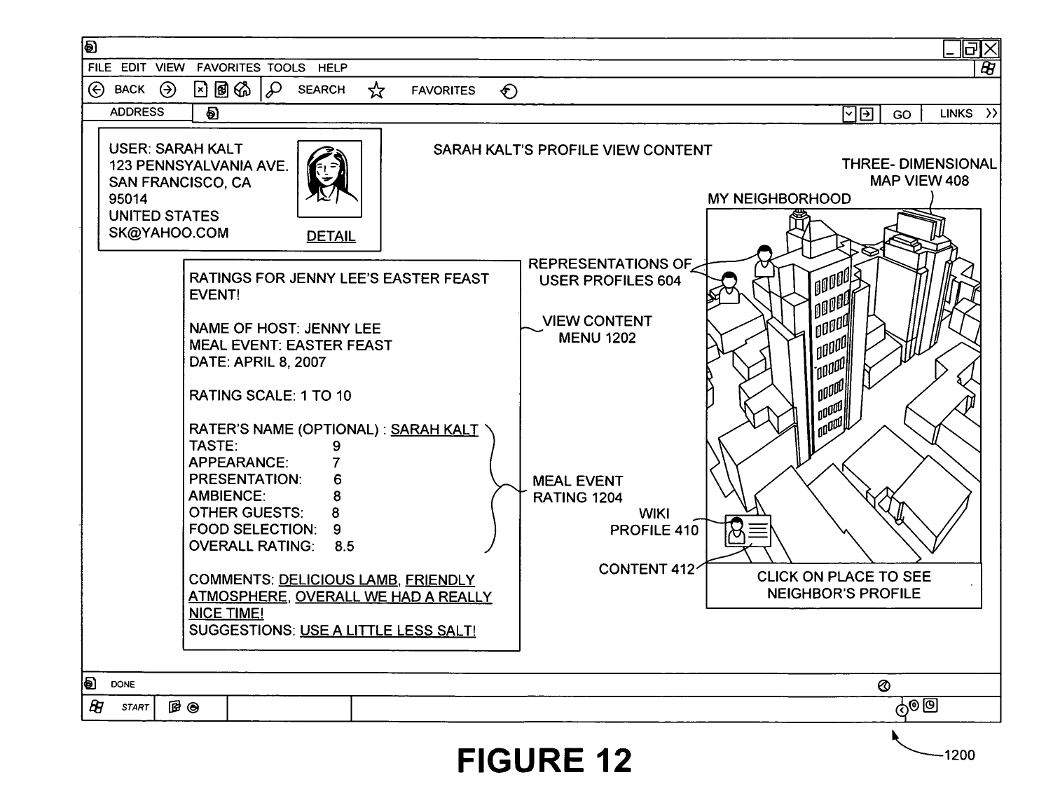

FIG. 12 is a user interface view 1200 showing ratings provided by a user, according to one embodiment. Particularly, FIG. 12 illustrates the three dimensional map view 408, the wiki profile 410, the content 412, the representations of user profiles 604, a view content menu 1202, and a meal event rating 1204, according to one embodiment.

The view content menu 1202 may display the comments and/or the suggestions made by the user 102 about the meal event 212A. The meal event rating 1204 may show the ratings made by the user 102 on the meal event 212A.

In the example embodiment illustrated in FIG. 12, the user interface view 1200 displays the ratings (e.g., taste, appearance, presentation and/or ambience, etc.) made by the user (e.g., Sarah Kalt) on the meal event 212A. Profile details of the user (e.g., Sarah Kalt) are also displayed in the user interface view 1200. The three dimensional map view 408 displays neighborhood profiles (e.g., the wiki profile 410 and/or the content 412) of the user 102. The view content menu 1202 displays name of the host, a date of the meal event, a time of the meal event, types of meal events, ratings for the meal event, rating scale, rater's name, etc.

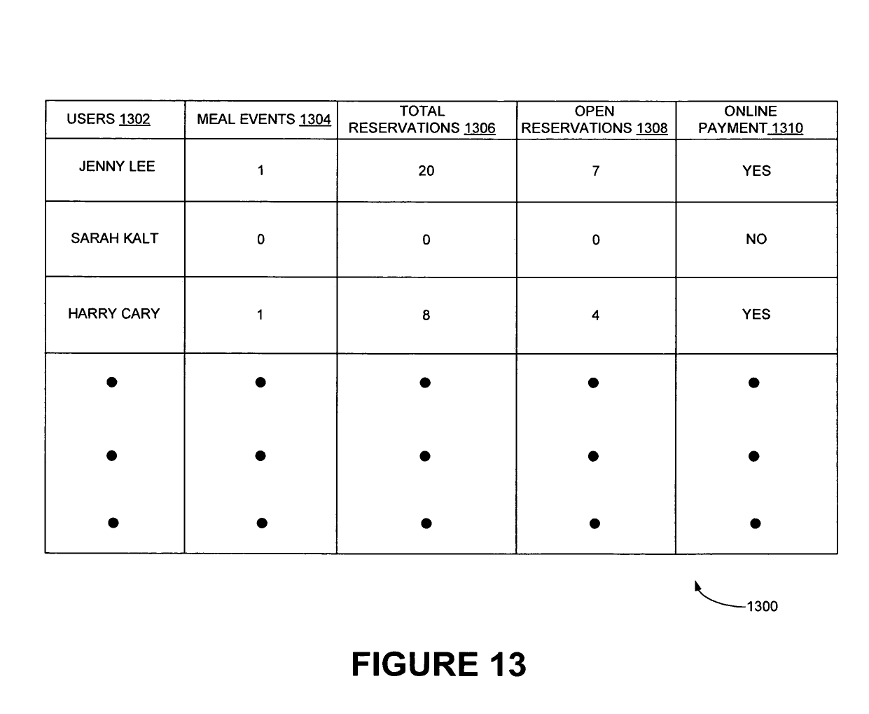

FIG. 13 is a table view 1300 showing information associated with the meal events 212, according to one embodiment. Particularly, FIG. 13 illustrates a users field 1302, a meal events field 1304, a total reservations field 1306, an open reservations field 1308, and an online payment field 1310, according to one embodiment.

The users field 1302 may display an identifier (e.g., a name, a username, a unique key, etc.) associated with the users 102 involved in the mealtime commerce. The meal events field 1304 may display number of the meal events 212 associated with the users 102 of the geo-spatial environment 100. The total reservations field 1306 may display total number of seats available at the meal event 212A. The open reservations field 1308 may display remaining number of seats available for reservations at the meal event 212A. The online payment field 1310 may display whether or not facilities for online payment are available for the transactions involved in the mealtime commerce.

In the example embodiment illustrated in FIG. 13, the users field 1302 displays “Jenny Lee” in the first row, “Sarah Kalt” in the second row and “Harry Cary” in the third row of the users field column 1302. The meal events field 1304 displays “1” in the first row, “0” in the second row and “1” in the third row of the meal events field column 1304 (e.g., one meal event is associated with the users Jenny Lee and Harry Cary but there is no meal event associated with the user Sarah Kalt). The total reservations field 1306 displays “20” in the first row, “0” in the second row and “8” in the third row of the total reservations field column 1306 (e.g., meal events associated with Jenny Lee have twenty seats for reservations, Sarah Kalt has no meal event and meal events associated with Harry Cary have eight seats for reservations). The open reservations field 1308 displays “7” in the first row, “0” in the second row and “4” in the third row of the open reservations field column 1308 (e.g., seven remaining seats for reservation at the meal event associated with Jenny Lee and four for the meal event associated with Harry Cary). The online payment field 1310 displays “Yes” in the first row, “No” in the second row and “Yes” in the third row of the online payment field column 1310 (e.g., there is a facility for online payment associated with the meal events of Jenny Lee and Harry Cary while there is no facility for online payment associated with the meal event of Sarah Kalt).

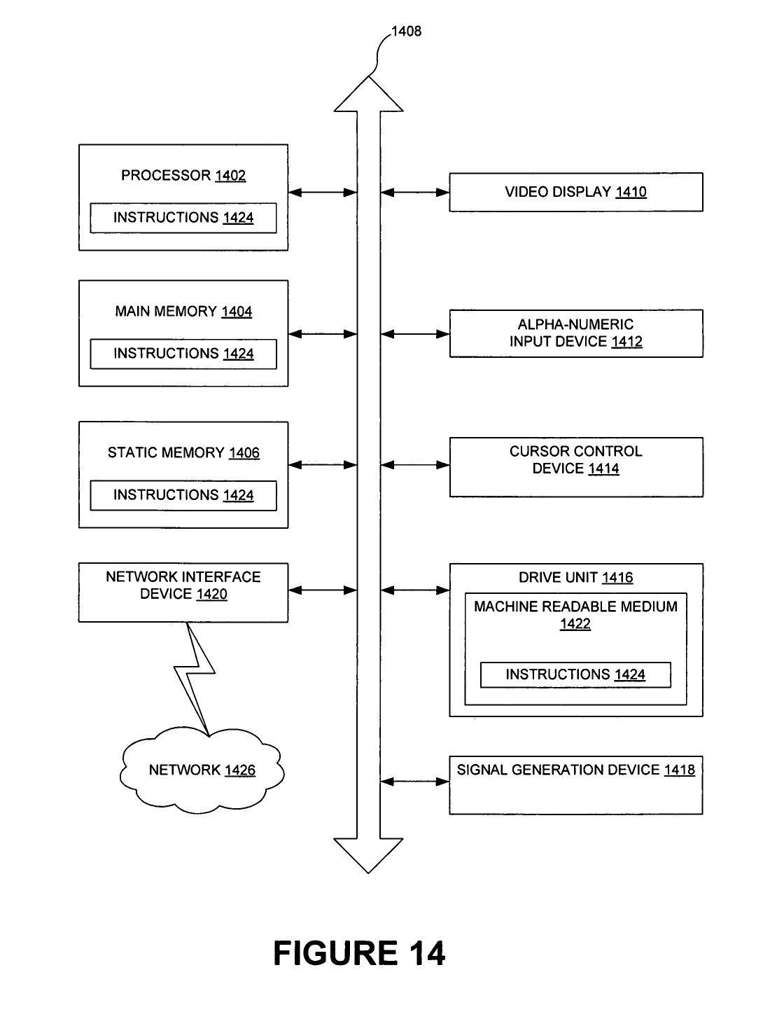

FIG. 14 is a diagrammatic system view 1400 of a data processing system in which any of the embodiments disclosed herein may be performed, according to one embodiment. Particularly, the diagrammatic system view 1400 of FIG. 14 illustrates a processor 1402, a main memory 1404, a static memory 1406, a bus 1408, a video display 1410, an alpha-numeric input device 1412, a cursor control device 1414, a drive unit 1416, a signal generation device 1418, a network interface device 1420, a machine readable medium 1422, instructions 1424, and a network 1426, according to one embodiment.

The diagrammatic system view 1400 may indicate a personal computer and/or the data processing system in which one or more operations disclosed herein are performed. The processor 1402 may be a microprocessor, a state machine, an application specific integrated circuit, a field programmable gate array, etc. (e.g., Intel® Pentium® processor). The main memory 1404 may be a dynamic random access memory and/or a primary memory of a computer system.

The static memory 1406 may be a hard drive, a flash drive, and/or other memory information associated with the data processing system. The bus 1408 may be an interconnection between various circuits and/or structures of the data processing system. The video display 1410 may provide graphical representation of information on the data processing system. The alpha-numeric input device 1412 may be a keypad, a keyboard and/or any other input device of text (e.g., a special device to aid the physically handicapped). The cursor control device 1414 may be a pointing device such as a mouse.

The drive unit 1416 may be the hard drive, a storage system, and/or other longer term storage subsystem. The signal generation device 1418 may be a bios and/or a functional operating system of the data processing system. The network interface device 1420 may be a device that may perform interface functions such as code conversion, protocol conversion and/or buffering required for communication to and from the network 1426. The machine readable medium 1422 may provide instructions on which any of the methods disclosed herein may be performed. The instructions 1424 may provide source code and/or data code to the processor 1402 to enable any one/or more operations disclosed herein.

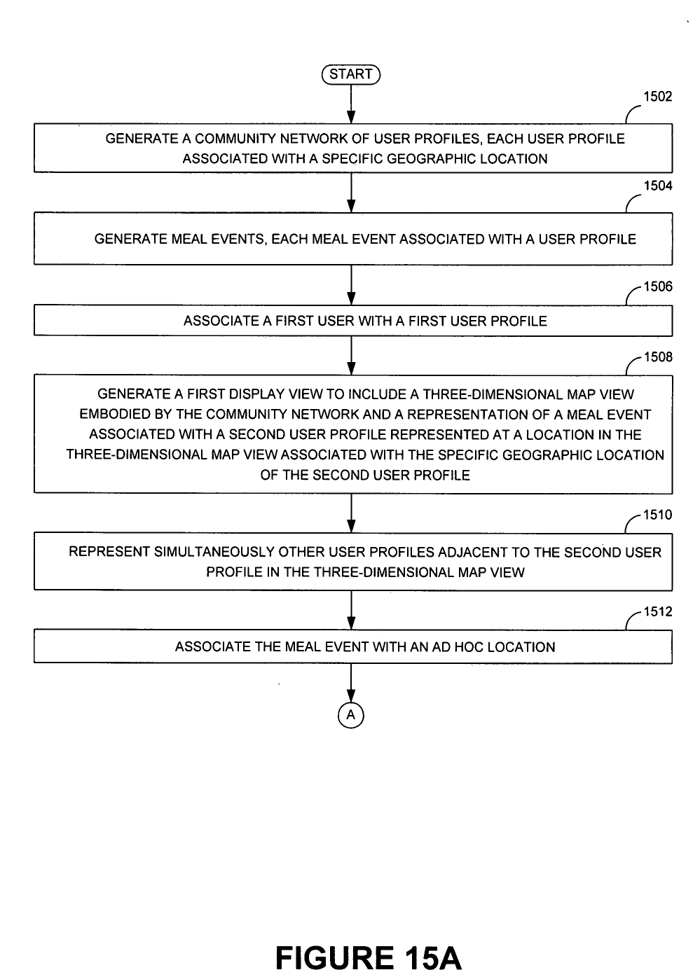

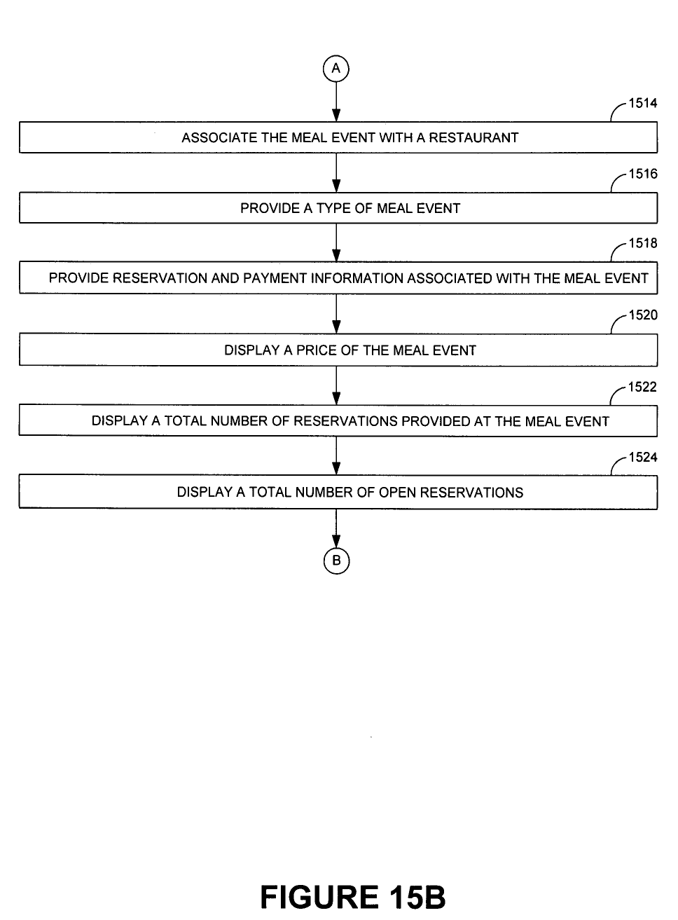

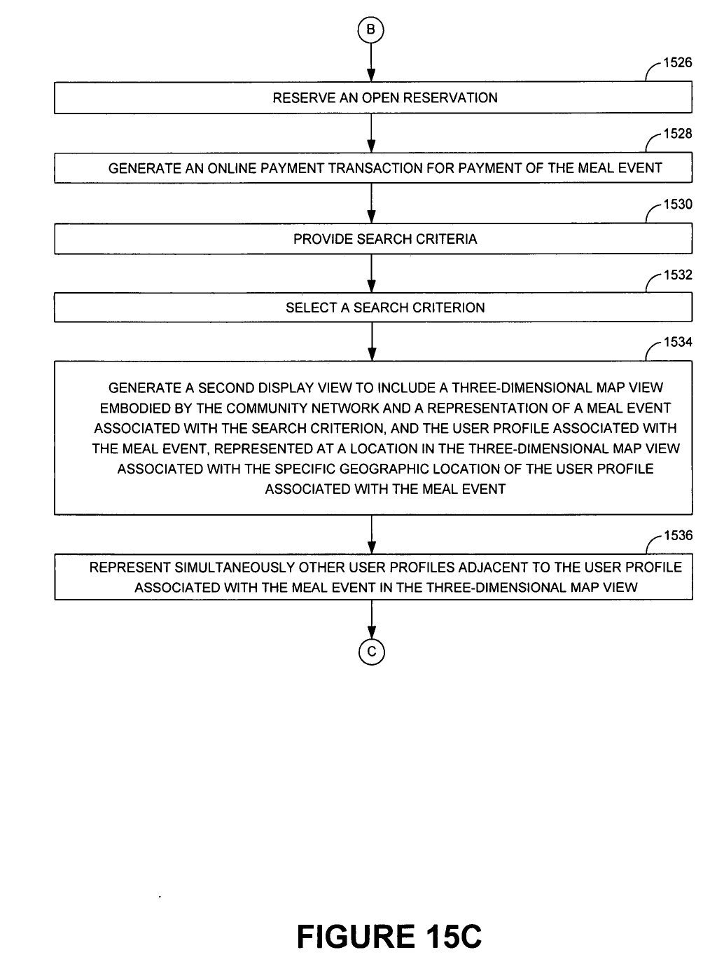

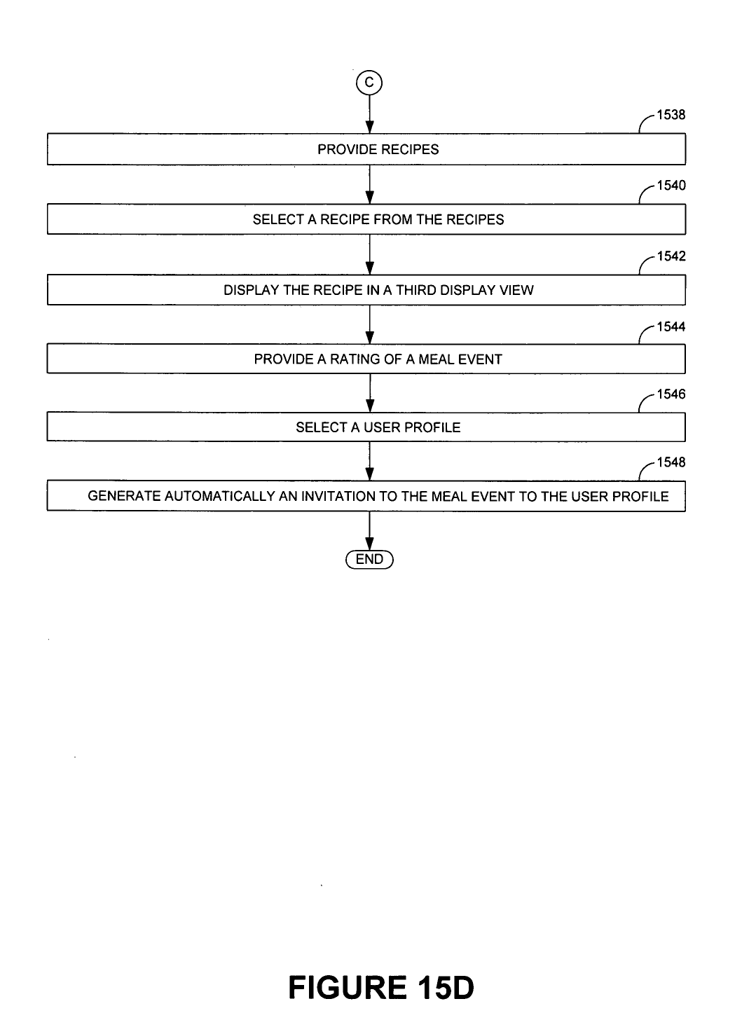

FIG. 15A is a process flow of generating meal events associated with user profiles 204, according to one embodiment. In operation 1502, a community network (e.g., the community network 200 of FIG. 2) of user profiles (e.g., the user profiles 204 of FIG. 2) may be generated (e.g., using the community network module 106 of FIG. 1), each user profile 204 associated with a specific geographic location (e.g., the specific geographic location 206 of FIG. 2). In operation 1504, meal events (e.g., the meal events 212 of FIG. 2) may be generated, each meal event 212 associated with a user profile 204. In operation 1506, a first user 102 may be associated with a first user profile (e.g., the first user profile 204A of FIG. 4).

In operation 1508, a first display view (e.g., the display view 418 of FIG. 4) may be generated to include a three dimensional map view (e.g., the three dimensional map view 408 of FIG. 4) embodied by the community network 200 and a representation of a meal event 606 associated with a second user profile 204 represented at a location in the three dimensional map view 408 associated with the specific geographic location 206 of the second user profile 204 (e.g., using the display module 110 of FIG. 1). In operation 1510, other user profiles (e.g., the other user profiles 204B of FIG. 4) may be simultaneously represented adjacent to the second user profile 204 in the three dimensional map view 408. In operation 1512, the meal event (e.g., the meal event 212A of FIG. 4) may be associated with an ad hoc location.

FIG. 15B is a continuation of the process flow of FIG. 15A, showing additional processes, according to one embodiment. In operation 1514, the meal event 212A may be associated with a restaurant. In operation 1516, a type of meal event (e.g., the type of meal event 508 of FIG. 5) may be provided. In operation 1518, reservation and/or payment information associated with the meal event 212A may be provided (e.g., using the reservation module 302 of FIG. 3). In operation 1520, a price of the meal event 212A may be displayed (e.g., using the display module 110 of FIG. 1). In operation 1522, a total number of reservations provided at the meal event 212A may be displayed (e.g., using the display reservations module 302A of FIG. 3). In operation 1524, a total number of open reservations may be displayed.

FIG. 15C is a continuation of the process flow of FIG. 15B, showing additional processes, according to one embodiment. In operation 1526, an open reservation may be reserved (e.g., for a user 102, using the reservation module 302 of FIG. 3). In operation 1528, an online payment transaction (e.g., the online payment transaction 404 of FIG. 4) may be generated for payment of the meal event 212A (e.g., using the payment module 304A of FIG. 3). In operation 1530, search criteria (e.g., the search criteria 502 of FIG. 5) may be provided (e.g., through the search module 306 of FIG. 3). In operation 1532, a search criterion may be selected.

In operation 1534, a second display view may be generated to include a three dimensional map view (e.g., the three dimensional map view 408 of FIG. 4) embodied by the community network 200 and a representation of a meal event 606 associated with the search criterion, and the user profile 204 associated with the meal event 212A, represented at a location in the three dimensional map view 408 associated with the specific geographic location 206 of the user profile 204 associated with the meal event 212A. In operation 1536, other user profiles (e.g., the other user profiles 204B of FIG. 4) may be simultaneously represented adjacent to the user profile 204 associated with the meal event 212A in the three dimensional map view 408.

FIG. 15D is a continuation of the process flow of FIG. 15C, showing additional processes, according to one embodiment. In operation 1538, recipes may be provided. In operation 1540, a recipe may be selected from the recipes. In operation 1542, the recipe may be displayed (e.g., using the display module 110 of FIG. 1) in a third display view. In operation 1544, a rating of a meal event may be provided (e.g., using the rating module 308 of FIG. 3). In operation 1546, a user profile (e.g., the user profile 204 of FIG. 2) may be selected. In operation 1548, an invitation to the meal event 212A may be automatically generated to the user profile 204.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated circuitry (ASIC) and/or in Digital Signal Processor (DSP) circuitry).

For example, the community network module 106, the map module 108, the display module 110, the additional modules 112, the reservation module 302, the display reservations module 302A, the commerce module 304, the payment module 304A, the search module 306, the rating module 308, the wiki profile module 310, the append module 312 and other modules of FIGS. 1-12 may be enabled using a community network circuit, a map circuit, a display circuit, additional circuit, a reservation circuit, a display reservations circuit, a commerce circuit, a payment circuit, a search circuit, a rating circuit, a wiki profile circuit, an append circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles associated with a specific geographic location;
generating meal events, each meal event of the meal events associated with a user profile of the user profiles;
associating a first user with a first user profile;
generating a first display view to include a three dimensional map view embodied by the community network and a representation of a meal event associated with a second user profile of the user profiles represented at a location in the three dimensional map view associated with the specific geographic location of the second user profile of the user profiles; and
simultaneously representing other user profiles adjacent to the second user profile of the user profiles in the three dimensional map view.

2. The method of claim 1, further comprising associating the meal event with an ad hoc location.

3. The method of claim 2, wherein the ad hoc location is selected from a group comprising a residence, a park, and a local gathering place.

4. The method of claim 2, wherein the meal event at the ad hoc location is exempt from health regulations.

5. The method of claim 1, further comprising associating the meal event with a restaurant.

6. The method of claim 1, further comprising providing a type of meal event.

7. The method of claim 6, wherein the type of meal event is selected from a group comprising a cuisine, a menu, specific food items, a holiday meal, and a special event meal.

8. The method of claim 7, wherein the cuisine is selected from a group comprising Indian, Italian, Iranian, Chinese, That, Japanese, Mediterranean, Mexican, Greek, Brazilian, Nepali, Cajun and Creole, Caribbean, Lebanese, Middle Eastern, Vietnamese, French, Spanish, American, Portuguese, Southwestern, Southern and Soul, Chilean, Moroccan, Cuban, Turkish, Swedish, Californian, German, Peruvian, Afghan, Ethiopian, Korean, Irish, and English.

9. The method of claim 7, wherein the holiday meal is selected from a group comprising Christmas, Kwanzaa, Hanukkah, New Year's, Fourth of July, Chinese New Year, Cinco de Mayo, Easter, Father's Day, Mother's Day, Halloween, Labor Day, Mardi Gras, Day.

10. The method of claim 7, wherein the special event meal is selected from a group comprising a birthday meal, a celebrated event meal, a religious event meal, a graduation meal, and a welcome to the neighborhood meal.

11. The method of claim of 1, further comprising providing reservation and payment information associated with the meal event.

12. The method of claim 11, further comprising:
displaying a price of the meal event;
displaying a total number of reservations provided at the meal event;
displaying a total number of open reservations;
reserving at least one open reservation of the open reservations; and
generating an online payment transaction for payment of the meal event.

13. The method of claim 1, further comprising:
providing search criteria;
selecting at least one search criterion of the search criteria;
generating a second display view to include a three dimensional map view embodied by the community network and a representation of at least one meal event associated with the at least one search criterion, and a user profile associated with the at least one meal event, represented at a location in the three dimensional map view associated with the specific geographic location of the user profile associated with the at least one meal event; and
simultaneously representing other user profiles adjacent to the user profile associated with the at least one meal event in the three dimensional map view.

14. The method of claim 13, wherein the at least one search criterion is selected from a group comprising a geographic area, a restaurant, a name, a street address of a residence, a cuisine, a menu, a food item, a meal event having open reservations, a date, a time, and a recipe.

15. The method of claim 1, further comprising:
providing recipes;
selecting a recipe from the recipes; and
displaying the recipe in a third display view.

16. The method of claim 15, wherein the recipe comprises an online cooking video.

17. The method of claim 1, further comprising providing a rating of the meal event.

18. The method of claim 17, wherein the rating is displayed in conjunction with at least one of a wiki profile associated with the second user profile associated with the meal event; and content associated with the wiki profile.

19. The method of claim 1, further comprising:
selecting at least one user profile of the user profiles; and
automatically generating an invitation to the meal event to the at least one user profile of the user profiles.

20. The method of claim 1 in a form of a machine-readable medium embodying a set of instructions that, when executed by a machine, causes the machine to perform the method of claim 1.

21. A system, comprising:
a geo-spatial environment;
a community network module of the geo-spatial environment, to include user profiles, each user profile of the user profiles to include a specific geographic location, and meal events, each meal event associated with a user profile of the user profiles;
a map module of the geo-spatial environment to include map data which serves as a basis to render a three dimensional map view in the geo-spatial environment which identifies at least some residences, businesses, civic structures, dwellings, and meal events having specific geographic locations; and
a display module of the geo-spatial environment to generate a first display view to include the three dimensional map view embodied by the community network and a representation of a particular meal event associated with a particular user profile of the user profiles represented at a location in the three dimensional map view associated with the specific geographic location of the particular user profile of the user profiles.

22. The system of claim 21, further comprising, a reservation module of the geo-spatial environment to generate a reservation associated with the particular meal event of the meal events.

23. The system of claim 22, comprising, a display reservations module of the geo-spatial environment to display a total number of reservations associated with the particular meal event and a total number of open reservations associated with the particular meal event of the meal events.

24. The system of claim 21, further comprising a commerce module of the geo-spatial environment to generate information and online transactions associated with the particular meal event of the meal events.

25. The system of claim 24, comprising a payment module of the geo-spatial environment to provide payment information and to generate an online payment transaction associated with the particular meal event of the meal events.

26. The system of claim 21, comprising a search module of the geo-spatial environment to provide search criteria associated with the meal events, to permit selection of at least one search criterion of the search criteria, and to generate meal events matching the at least one search criterion of the meal events.

27. The system of claim 26, wherein the at least one search criterion is selected from a group comprising a geographic area, a venue, a type of meal event, a restaurant name, a person's name, a street address of a residence, a menu, a food item, a meal event with open reservations, a date, a time, and a recipe.

28. The system of claim 27, wherein the geographic area is selected from a group comprising a neighborhood associated with a street address, a city, a county, a state, and a country.

29. The system of claim 27, wherein the venue is selected from a group comprising an ad hoc location and a restaurant.

30. The system of claim 29, wherein the ad hoc location is selected from a group comprising a residence, a park, and a local gathering place.

31. The system of claim 29, wherein the ad hoc location comprises an ad hoc location where the particular meal event is exempt from health regulations.

32. The system of claim 27, wherein the type of meal event is selected from a group comprising a cuisine, a menu, specific food items, a holiday meal, and a special event meal.

33. The system of claim 32, wherein the cuisine is selected from a group comprising Indian, Italian, Iranian, Chinese, That, Japanese, Mediterranean, Mexican, Greek, Brazilian, Nepali, Cajun and Creole, Caribbean, Lebanese, Middle Eastern, Vietnamese, French, Spanish, American, Portuguese, Southwestern, Southern and Soul, Chilean, Moroccan, Cuban, Turkish, Swedish, Californian, German, Peruvian, Afghan, Ethiopian, Korean, Irish, and English.

34. The system of claim 32, wherein the holiday meal is selected from a group comprising Christmas, Kwanzaa, Hanukkah, New Year's, Fourth of July, Chinese New Year, Cinco de Mayo, Easter, Father's Day, Mother's Day, Halloween, Labor Day, Mardi Gras, Memorial Day, Oktoberfest, Passover, St. Patrick's Day, Thanksgiving, and Valentine's Day.

35. The system of claim 32, wherein the special event meal is selected from a group comprising, a birthday meal, a celebrated event meal, a religious event meal, a graduation meal, and a welcome to the neighborhood meal.

36. The system of claim 21, further comprising a rating module of the geo-spatial environment to enable ratings of the meal events.

37. The system of claim 21, further comprising a wiki profile module of the geo-spatial environment to generate in the first display view, a wiki profile associated with a user profile of the user profiles.

38. The system of claim 37, further comprising an append module of the geo-spatial environment to generate with at least one wiki profile, content associated with the at least one wiki profile.

39. A geo-spatial environment, comprising:
a first instruction set to enable a community network, to include a map database associated with map data, a user database associated with user profiles, each user profile of the user profiles associated with a specific geographic location identifiable in the map data, and a meal event database associated with meal events, each meal event of the meal events associated with a user profile of the user profiles; and
a second instruction set integrated with the first instruction set to display a three dimensional map view, embodied by the community network, to include representations of at least a portion of the meal events and representations of the user profiles associated with the at least a portion of the meal events displayed at a location in the three dimensional map view corresponding to the specific geographic location associated with each user profile associated with the at least a portion of the meal events.

40. The geo-spatial environment of claim 39, further comprising a third instruction set to generate a reservation and an online payment transaction associated with the meal event.

41. The geo-spatial environment of claim 39, further comprising a fourth instruction set to generate a search, associated with the meal events, based on at least one search criterion.

42. The geo-spatial environment of claim 39, further comprising a fifth instruction set to enable ratings of the meal events
